(19) United States
(12) Patent Application Publication
(10) Pub. No.: US 2021/0376403 A1
(43) Pub. Date: Dec. 2, 2021

(54) BATTERY MODULE FOR BATTERY AND MOTOR VEHICLE WITH BATTERY AS WELL AS OPERATING METHOD

(71) Applicant: AUDI AG, Ingolstadt (DE)

(72) Inventor: Oliver SCHIELER, Gaimersheim (DE)

(73) Assignee: AUDI AG, Ingolstadt (DE)

(21) Appl. No.: 17/319,349

(22) Filed: May 13, 2021

(30) Foreign Application Priority Data
May 27, 2020 (DE) 10 2020 114 187.4

(51) Int. Cl. H01M 10/653; H01M 10/625; H01M 10/613; H01M 10/647; H01M 50/121

(52) U.S. Cl. CPC H01M 10/653; H01M 10/625; H01M 2220/20; H01M 10/647; H01M 50/121; H01M 10/613

(57) ABSTRACT

A battery module for a battery of a motor vehicle, with multiple battery cells. Each of the battery cells is at least partially encased by an encasing material including a silicone. At a first temperature (T1) of each of the battery cells which is lower than a limit temperature (TG) predetermined by the encasing material, the encasing material has a first thermal conductivity (L1), and, at a second temperature (T2) of at least one battery cell of the multiple battery cells, higher than or equal to the limit temperature (TG), the encasing material at least partially has a second thermal conductivity (L2) increased with respect to the first thermal conductivity (L1).

### FIELD

The disclosure relates to a battery module for a battery of a motor vehicle. The battery module comprises multiple battery cells, wherein each of the battery cells is at least partially encased by an encasing material comprising a silicone. The disclosure further relates to a motor vehicle with a battery as well as to a method for operating such a battery module.

### BACKGROUND

A battery for an at least partially electrically driven motor vehicle comprises one or more battery modules, each comprising a battery cell or multiple battery cells. Said battery cells can in each case be designed, for example, as a prismatic cell, a round cell or a pouch cell. Such a battery cell here preferably provides a voltage in the range between 3.5 and 4.0 volt. In particular, the respective battery module comprises a plurality of electrically interconnected battery cells. By means of an electrical interconnection of the battery cells, such a battery can provide, for example, on the basis of multiple battery cells, an electrical voltage of more than 60 volt and in particular of more than 100 volt, which is why it is then also referred to as a high-voltage battery. Preferably, the battery cells are arranged one top the other in order to form at least one cell stack and are mechanically clamped to one another by means of a clamping device.

It is known that a volume or a thickness of the battery cell increases with advancing or increasing lifetime. Such a gradual growth, i.e., a so-called swelling, of the battery cell is additionally superposed by swelling and subsiding intervals, wherein a respective swelling interval is associated with at least one electrical charging of the battery cell, and a respective subsiding interval is associated with an electrical discharging of the battery cell. Such a swelling and subsidence as well as a higher-level growth of the battery cell lead to a mechanical stressing of the battery cell and, in further consequence, of the battery. Furthermore, in the battery cell, in particular in its galvanic cell, a damage event (for example, an internal short circuit) can occur. Due to a resulting chemical reaction, a gas mixture depending on a cell chemistry can form and accumulate in an interior of the battery cell. As a result of such a gas development, an overpressure can build up within the damaged battery cell and lead to the gas mixture escaping from the battery cell in the form of a gas and/or flame jet. This chemical reaction caused by a damage event generally moreover leads to considerable heating of the affected battery cell and its immediate vicinity.

From the prior art, various approaches to counteract such chemical reactions are known. For example, DE 10 2013 113 797 A1 and DE 10 2013 113 799 A1 each describe a battery module comprising multiple battery cells. Between two of the battery cells, a fire protection element and a damping foam layer (for example, plastic, silicone) are arranged. In addition, the foam layer can be used for a mechanical securing of the battery cells in the case of a possible vacuum loss of the battery cells. As foam, a material which also has a fire protection function can be used.

CN108493513A discloses a battery module with a thermally conductive structure. The battery module comprises multiple cylindrical battery cells, between which thermally conductive silicone pads are arranged. Said silicone pads can also serve as a protective damping.

In this light, the aim of the present disclosure therefore is to allow, in a battery module of the type described at the start, for a battery, a swelling and subsidence as well as a volume increase of a battery cell over its entire lifespan under controlled pressure conditions and furthermore to isolate it in a damage event, wherein a mounting of the battery is to be cost effective, optimized for installation space and at the same time simplified. Furthermore, the aim of the present disclosure is to provide a motor vehicle with such a battery as well as a corresponding operating method.

The aim is achieved by the subject matters of the independent claims. Advantageous developments of the disclosure are described by the dependent claims, the following description and the figures.

### SUMMARY

The disclosure is based on the finding that, in a gap between two battery cells of a battery designed as high-voltage battery, at least two functional layers are introduced. A first layer is used here for absorbing so-called swelling forces. A second layer can be used for a thermal insulation in the case of a runaway battery cell of the battery cells and can be designed, for example, as a mica layer. The thermal insulation protects the at least one battery cell adjacent to the continuous battery cell and in the process such a damage event can be locally limited. The disadvantages here are the high costs of each of the at least two layers as well as a large number of production steps in a production (for example, positioning and gluing of each of the layers). This can be counteracted by the disclosure.

By means of the disclosure, a battery module for a motor vehicle battery of the type mentioned at the start is provided. The battery module comprises multiple battery cells. Thus, a plurality of battery cells are arranged within the battery module. Within the battery module, the battery cells can be positioned with spacing from one another, so that a gap is formed in each case between two adjacent battery cells. The battery cells which delimit the battery module from the outside, i.e., the terminal battery cells, can in each case be bound by a clamping device (a module connector or side binder). By means of the respective clamping device, a clamping pressure can be applied to the battery cells already at the time of the mounting of the battery.

Furthermore, each of the battery cells is at least partially encased by an encasing material comprising a silicone. Thus, the battery module comprises in particular a respective cell stack of the battery module, that is to say a layered structure of battery cells and encasing material. The encasing material at least partially covers each of the battery cells. In particular, the encasing material does not cover the entire surface of each of the battery cells but only sections. The encasing material can here be arranged between each of the battery cells and the battery cells arranged adjacently thereto. In each case, due to the encasing material, the respective adjacent battery cells of the battery cells are separated from one another. The encasing material comprises silicone, i.e., a synthetic polymer, with multiple silozane units, in which silicon atoms are linked via oxygen atoms and form molecule chains and/or networks. The silicone can be, for example, in the form of a silicone rubber, a silicone elastomer or a silicone resin. In particular, the silicone can exhibit low volatility in order to counteract siloxane outgas sing.

In addition, it is provided that the encasing material has two temperature-dependent thermal conductivities which differ from one another. Thus, a temperature predetermines a respective heat conductivity. In the sense of the disclosure, thermal conductivity or heat conductivity is to be understood to be a material property of the encasing material which gives a quantitative indication of a heat flow through the encasing material due to heat conduction in Watt per meter and kelvin. Here, the encasing material transports the heat flow without substance transport. An inverse of the heat conductivity indicates a heat resistance. At a first temperature of each of the battery cells lower than a limit temperature predetermined by the encasing material, the encasing material can have a first thermal conductivity. At a second temperature of at least one battery cell of the multiple battery cells higher than or equal, i.e. greater than or equal, to the limit temperature, the encasing material at least partially has a second thermal conductivity. Here, the second thermal conductivity is increased with respect to the first thermal conductivity. This means that the encasing material at the first thermal conductivity damps heat and at the second thermal conductivity conducts heat comparatively better. The limit temperature in this context describes the temperature at which the thermal conductivity of the encasing material changes, i.e., transitions from the first thermal conductivity to the second thermal conductivity. For example, the limit temperature is a silicatization temperature starting at which a decomposition of the silicone-based encasing material to a dimensionally stable ceramic is to be expected. Such a change can occur in particular abruptly. For example, the first temperature can lie within a normal temperature range during operation of the battery cells according to the intended use and/or can indicate a standard operating temperature of the battery cells. Here, the encasing material can preferably be thermally insulating, in order to minimize a mutual thermal influencing of the battery cells among one another. Thereby, at the first thermal conductivity, an energy flow from the at least one battery cell can be reduced by an insulating property of the encasing material. If a cell-specific temperature of the at least one battery cell increases, i.e., if it increases proceeding from the first temperature, exceeds the limit value and finally reaches the second temperature, then the heat conductivity of the encasing material changes. Here, the encasing material having the second heat conductivity can be designed to receive energy flow from the at least one battery cell in order to cool said battery cell. Such a temperature increase can be ascribed, for example, to a runaway of the at least one battery cell in a damage event. Since the temperature increase results in a change of the heat conductivity, the encasing material is at first thermally insulating, in order to particularly efficiently dissipate heat from the at least one runaway battery cell after the temperature increase and in order to prevent overheating of the other battery cells. By dissipating the heat, the at least one runaway battery cell can also be cooled.

By means of the disclosure, the advantage arises that, with reduced material use in comparison to the known solutions, an effective heat control is provided, both in operation according to intended use of the battery cells and also in the event of damage of the at least one damaged battery cell. Because only the encasing material is to be arranged between the battery cells, the mounting of the battery according to the disclosure is advantageously simplified. By means of the reduced material use and the cost effective encasing material, production costs can moreover advantageously be saved, and an installation space can be used more efficiently, since one of at least two layers can be substituted.

An advantageous embodiment provides that, after a predetermined time period, of the at least one battery cell having the second temperature, the encasing material has a third thermal conductivity instead of the second thermal conductivity, wherein the third thermal conductivity is lower than the second thermal conductivity. If, at the second temperature of the at least one battery cell, the second thermal conductivity is present at least partially in the encasing material, then said second thermal conductivity decreases to the third conductivity after a predetermined time period. Thus, a change of the heat conductivity with increasing time, caused by a temperature increase from the first temperature to the second temperature, is at least partially reversible. For example, the heat conductivity decreases because a temperature-caused change to the second thermal conductivity comes to a halt. As a result, the encasing material advantageously can provide a thermal insulation function for the at least one battery cell. Moreover, the at least one damaged battery cell can be identified particularly simply based on the third conductivity of the other battery cells of the battery cells. This results in the advantage that a possible temperature- and time-caused change of the heat conductivity of the encasing material can be tracked particularly simply, since an impact of a damage-caused strong heating of the at least one battery cell on said battery cell and its immediate vicinity can be limited.

An additional advantageous embodiment provides that, below the limit temperature, the encasing material applies a predetermined pressure to each of the battery cells, in order to control an expansion of each of the battery cells. Thus, below the limit temperature, the encasing material of each of the battery cells can absorb forces generated by swelling and subsidence as well as by a volume increase of each of the battery cells, i.e., so-called swelling forces. This means that in the gap between the battery cells an operation-caused deformation or an expansion of the battery cells can occur, without this leading to an elongation of the cell stack or of the battery module and to an associated disadvantageous relative movement. Thereby, advantageously, an equal mechanical load, i.e., a homogeneous pressure distribution on each battery cell/each of the battery cells can be ensured. This can have a positive effect on a lifespan and/or an aging behavior of the battery cells. Moreover, a cost intensive swelling pad can be dispensed with.

An additional advantageous embodiment provides that, in an immediate vicinity of the at least one battery cell having the second temperature, the encasing material comprises Si—O groups and/or Si—OH groups generated by the second temperature. Thus, the encasing material immediately forms a silicate layer consisting of silicon oxides (SiOx) where the limit temperature is exceeded, i.e., in a region close to the at least one battery cell which has the second temperature. Here, the encasing material can decompose in this region to form a dimensionally stable ceramic layer. Thus, the limit temperature can indicate a decomposition temperature of the encasing material. Such a decomposition is a so-called thermal silicatization. During the silicatization, the encasing material absorbs energy of the at least one damaged battery cell and thereby cools said battery cell. In the region of the ceramic layer, the silicatized encasing material is thermally insulating and thus advantageously protects battery cells other than the at least one damaged battery cell against propagation of the damage event.

An additional advantageous embodiment provides that, proceeding from a contact surface with the at least one battery cell having the second temperature, the encasing material forms a covering layer having the second thermal conductivity, with a layer thickness of maximum 1.5 millimeters. Thus, a section of the encasing material having the second thermal conductivity adjoins the at least one battery cell which has the second temperature. This section is predetermined by the contact surface between the two, i.e., the surface at which the at least one battery cell having the second temperature and the encasing material are in contact with one another, and it has a layer thickness of less than 1.5 millimeters. In particular, the layer thickness can indicate a respective normal spacing proceeding from the contact surface, i.e., it can establish a material thickness of the encasing material which covers the at least one of the battery cells which has the second temperature. In the case of a maximum extension, the extension then can occupy the entire gap between two adjacent battery cells, i.e., proceeding from the at least one damaged battery cell to another battery cell arranged on said damaged battery cell. This results in the advantage that the encasing material only selectively has a second thermal conductivity, and, after the damage event, the battery cells which are not affected thereby can optionally possibly be recycled for further use.

An additional advantageous embodiment provides that the limit temperature of the encasing material is between 300 and 500 degrees Celsius. Thus, in the encasing material, the first thermal conductivity is present when each of the battery cells has the first temperature, which is lower than the limit temperature which is between 300 and 500 degrees Celsius. On the other hand, if the at least one battery cell has the second temperature above such a temperature range, then the encasing material at least partially also has the second thermal conductivity. This results in the advantage that, already with a temperature increase to 300 to 500 degrees Celsius, a change of the thermal conductivity occurs. Thereby, the battery can be operated particularly safely and the use of a high-temperature-resistant silicone can be dispensed with.

An additional advantageous embodiment provides that the encasing material comprises multiple hollow bodies encased by the silicone, with a volume proportion between 70 and 90 percent. The volume proportion thus indicates a ratio of the silicone with respect to the hollow bodies arranged thereon, i.e., a composition of the encasing material. Here, a volume of the hollow bodies (70 to 90 percent) is expressed with respect to a sum of a volume of the silicone and the volume of the hollow bodies (in total 100 percent). The hollow bodies thus are used as a filler which is embedded in the silicone. In particular, the hollow bodies can be closed. For example, the hollow bodies can be designed as hollow beads comprising glass, ceramic and/or plastic. By means of the hollow bodies, advantageously, for example, a density of the encasing material can be reduced and/or a swelling force can be absorbed.

An additional advantageous embodiment provides that each of the battery cells is delimited by an upper side, a lower side, and at least one side surface. Each of the battery cells thus can be predefined by the lower side, the upper side facing the lower side, and the at least one side surface. On the side, i.e., between the upper side and the lower side, each of the battery cells is encased by the at least one side surface. Depending on a design of the respective battery cell (for example, prismatic, round or pouch cell) and a form predetermined thereby, the at least one side surface can represent a lateral surface of a cylinder which has a round and/or a polygonal base surface. Here, the at least one side surface is covered by the encasing material, and the upper side and the lower side are each not covered by the encasing material. Thus, the gap between two battery cells, which receives the encasing material, can extend between respective side surfaces of these battery cells, which are arranged parallel to one another. The upper side and the lower side are free, so that, for example, electrical connections arranged on the upper side can be connected to one another in an electrically conducting manner, i.e., put in contact, particularly simply via a respective cell connector, in accordance with a predetermined connection plan, and a cooling device can be arranged on the lower side.

A motor vehicle with a battery is moreover provided by the disclosure, wherein the battery comprises a battery module. The battery module preferably is an embodiment of the battery module according to the disclosure. The battery can provide electrical energy in the motor vehicle for driving and/or supplying the motor vehicle. In particular, the motor vehicle is designed as an electric vehicle or hybrid vehicle which can be driven by the battery. The motor vehicle is preferably designed as a car, in particular as a passenger car or a truck, or as a van or a motorcycle.

Also covered by the disclosure are developments of the motor vehicle according to the disclosure, which have features as already explained in connection with the developments of the battery module according to the disclosure and vice versa. For this reason, the corresponding developments of the motor vehicle according to the disclosure are not described again here.

A method for operating a battery module for a battery of a motor vehicle is provided by the disclosure. The battery module is preferably an embodiment of the battery module according to the disclosure. The battery module comprises multiple battery cells, wherein each of the battery cells is at least partially encased by an encasing material comprising a silicone, wherein the encasing material predetermines a limit temperature for two thermal conductivities which differ from one another. In order to arrange the encasing material within the battery module, this encasing material can first be prewetted and subsequently arranged between the battery cells. Alternatively or additionally, the encasing material can initially have a viscous state, can be filled in between the battery cells separated from one another by respective spacers and can be subsequently crosslinked, i.e., cured. In one step, each of the battery cells is operated at a first temperature which is lower than the limit temperature, wherein the encasing material has a first thermal conductivity. This involves in particular an operation of the battery according to intended use within a normal temperature range. In an additional step, at least one battery cell of the multiple battery cells is operated with a second temperature which is higher than or equal to the limit temperature, wherein the first conductivity of the encasing material is at least partially reduced to a second thermal conductivity. This involves in particular an operation of the battery outside of the intended use, which can describe, for example, a damage event (for example, a runaway of the at least one battery cell).

The disclosure also covers developments of the method according to the disclosure, which have features as already described in connection with the developments of the battery module according to the disclosure and/or of the motor vehicle according to the disclosure and vice versa. For this reason, the corresponding developments of the method according to the disclosure are not described again here.

The disclosure also comprises the combinations of the features of the described embodiments.

### BRIEF DESCRIPTION OF THE FIGURES

Below, embodiment examples of the disclosure are described. Here:

FIG. 1 shows a representation of a motor vehicle with a battery;

FIG. 2 shows a diagrammatic cross-sectional representation of a first embodiment of a battery module of the battery;

FIG. 3 shows a diagrammatic cross-sectional representation of a second embodiment of the battery module in a first operating state;

FIG. 4 shows a diagrammatic cross-sectional representation of the second embodiment of the battery module in a second operating state;

FIG. 5 shows a diagrammatic cross-sectional representation of the second embodiment of the battery module in a third operating state; and

FIG. 6 shows a diagrammatic cross-sectional representation of the second embodiment of the battery module in a fourth operating state.

### DETAILED DESCRIPTION

The embodiment examples explained below are preferred embodiments of the disclosure. In the embodiment examples, the described components of the embodiments each represent individual features of the disclosure to be considered independently of one another, which in each case also develop the disclosure independently of one another. Therefore, the disclosure should also cover combinations other than the represented combinations of the features of the embodiments. Moreover, the described embodiments can also be supplemented by features other than the already described features of the disclosure.

In the figures, identical reference numerals designate in each case functionally equivalent elements.

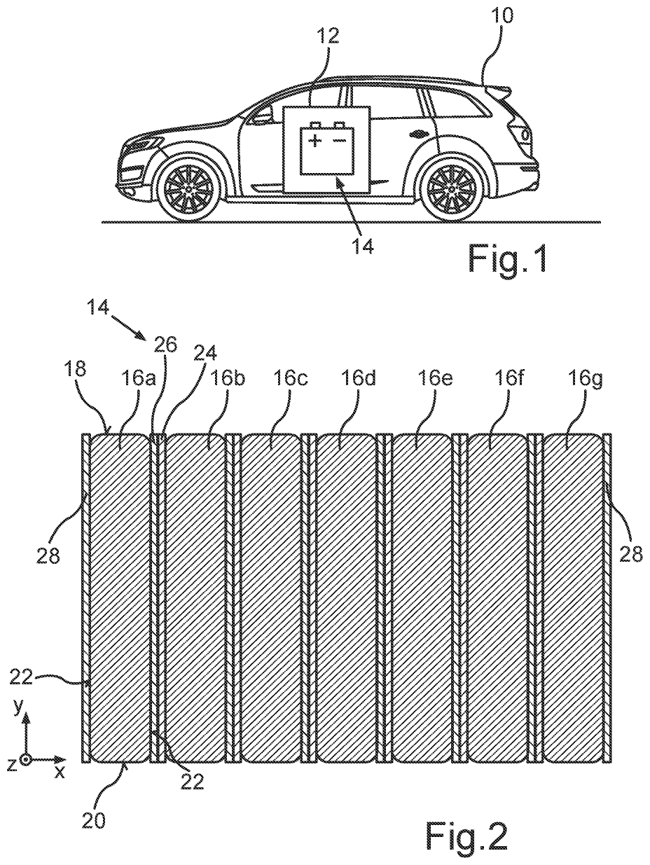

FIG. 1 shows, for example, a motor vehicle 10 with a diagrammatically indicated battery 12 which comprises a battery module 14. By means of the battery 12, the motor vehicle 10 can be electrically supplied and in particular at least partially driven. For this purpose, the battery 12 can be designed as so-called high-voltage battery.

FIG. 2 shows, in reference to the components shown and described in connection with those in FIG. 1, a first embodiment of the battery module 14 in a cross-sectional representation, known from the prior art. The battery module 14 shown comprises seven battery cells 16a, 16b, 16c, 16d, 16e, 16f, 16g each designed as prismatic cells, wherein each of the battery cells 16a-16g has an upper side 18 and a lower side 20 facing the upper side 18 in x direction as well as two side surfaces 22 in z direction. The battery cells 16a-16g are in each case arranged parallel to one another adjacently on the respective side surfaces 22. In a gap between two battery cells 16a-16g, two functional layers 24, 26 are introduced. A first layer 24 can be formed as a so-called swelling pad and absorb forces generated by an operation-caused expansion of the battery cells 16a-16g. A second layer 26 is formed, for example, as a mica layer and can provide a thermal insulation in the case of a runaway of a damaged battery cell of the battery cells 16a-16f, in order to protect the other battery cells 16a-16f. The terminal battery cells 16a, 16e have, on the respective outward directed side surface 22, a clamping device 28 (side binder). For the sake of simplicity, only the terminal battery cell 16a shown to the far left in FIG. 2 has the corresponding reference numerals 18, 20, 22, 24, 26.

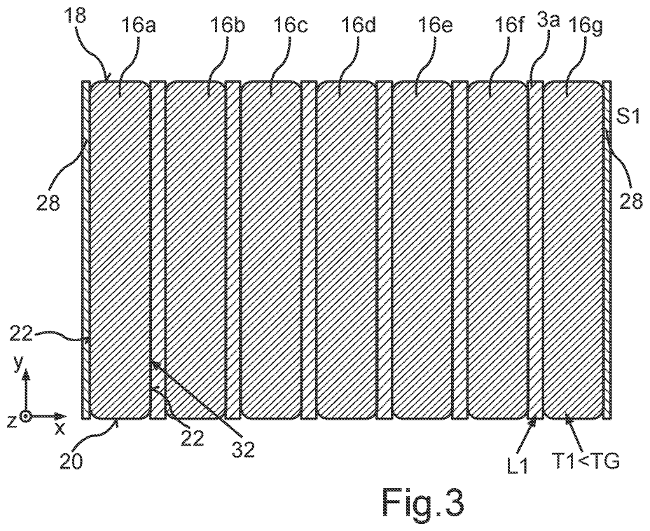

In reference to the components shown and described in connection with FIG. 1 and FIG. 2, FIG. 3 shows a second embodiment of the battery module 14 in a cross-sectional representation, wherein battery module 14 has a first operating state. Instead of the layers 24, 26 shown in FIG. 2, the gap is filled with an encasing material 30 which at least partially encases, i.e., covers, each of the battery cells 16a-16f. This means that the terminal battery cells 16a, 16g adjoin the encasing material 30 in each case on one of the side surfaces 22 and the middle-position battery cells 16b-16f adjoin said encasing material in each case on two of the side surfaces 22, wherein each of the battery cells 16a-16g forms at least one contact surface 32 with the encasing material 30. For the sake of simplicity, only the terminal battery cell 16a shown on the far left in FIG. 2 bears the reference numeral of the contact surface 32. The encasing material 30 can comprise a silicone. The silicone can, for example, encase multiple hollow bodies which can occupy a volume proportion between 70 and 90 percent of the encasing material 30. The upper side 18 and the lower side 20 of each of the battery cells 16a-16g are each not covered by the encasing material 30. In the first operating state, which corresponds to a step S1 of the method for operating the battery module 14, all the battery cells 16a-16g have a first temperature T1 which is lower than a predetermined limit temperature TG of the encasing material 30 (T1<TG), wherein the encasing material 30 has a first thermal conductivity L1. For the sake of simplicity, only the terminal battery cell 16g shown on the far right in FIG. 3 bears the corresponding reference numerals of the first temperature T1 which is lower than the limit temperature TG and the encasing material 30 adjoining it bears its reference numeral and the reference numeral of the first conductivity L1. In particular, the limit temperature TG can in particular be between 300 and 500 degrees Celsius. Furthermore, below the limit temperature TG, the encasing material 30 applies a predetermined pressure on each of the battery cells 16a-16g in order to control an expansion of each of the battery cells 16a-16g.

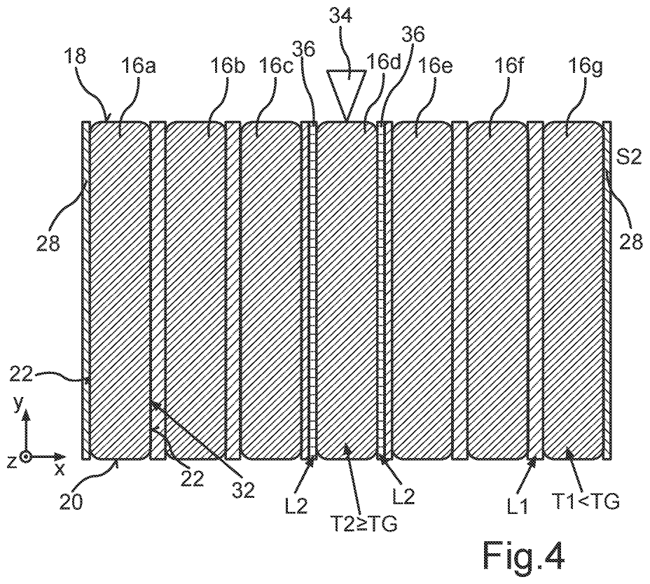

FIG. 4 shows, in reference to the components shown and described in connection with FIG. 1 to FIG. 3, the second embodiment of the battery module 14 in a second operating state. In the second operating state, which corresponds to an additional step S2 the method for operating the battery module 14, the battery cells 16a-16c, 16e-16g have the first temperature T1 and the fourth battery cell 16d from the left has a second temperature T2 which is increased with respect to the first temperature T1. This results from a runaway of the battery cell 16d, which can be caused, for example, by an internal short circuit. The runaway of the battery cell 16d is indicated with a diagrammatically represented flame and gas jet 34. The second temperature T2 is higher than or equal to the predetermined limit temperature TG of the encasing material 30 (T2≥TG), wherein the encasing material 30 at least partially has a second thermal conductivity L2 which is decreased with respect to the first thermal conductivity L1. A covering layer 36 having the second thermal conductivity L2 here proceeds from the contact surface 32 of the encasing material 30 with the battery cell 16d having the second temperature T2 in the direction of the encasing material 30. Thus, the encasing material 30 in an immediate vicinity of the battery cell 16d comprises the Si—O groups and/or Si—OH groups generated by the second temperature T2 due to a silicatization caused by the second temperature T2 of the battery cells 16d.

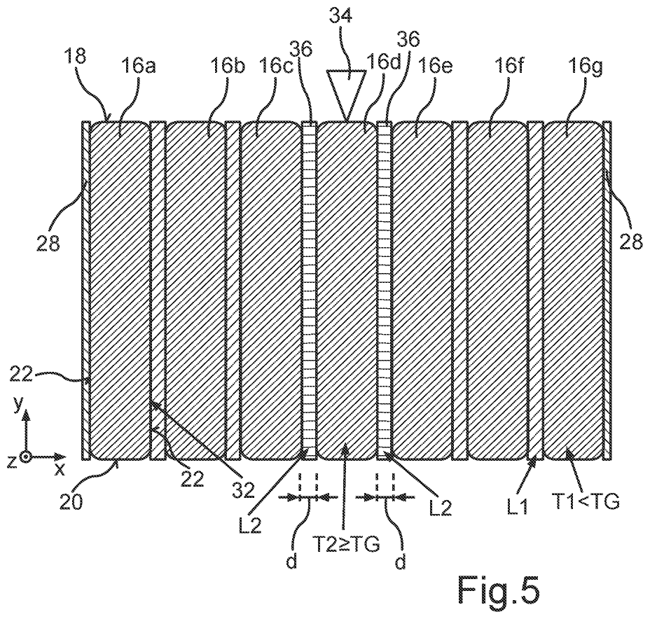

FIG. 5, in reference to the components shown and described in connection with FIG. 1 to FIG. 4, shows the second embodiment of the battery module 14 in a third operating state. Here the covering layer 36 has a layer thickness d of maximum 1.5 millimeters, which can occupy the entire gap between the battery cells 16c, 16d and 16d, 16e.

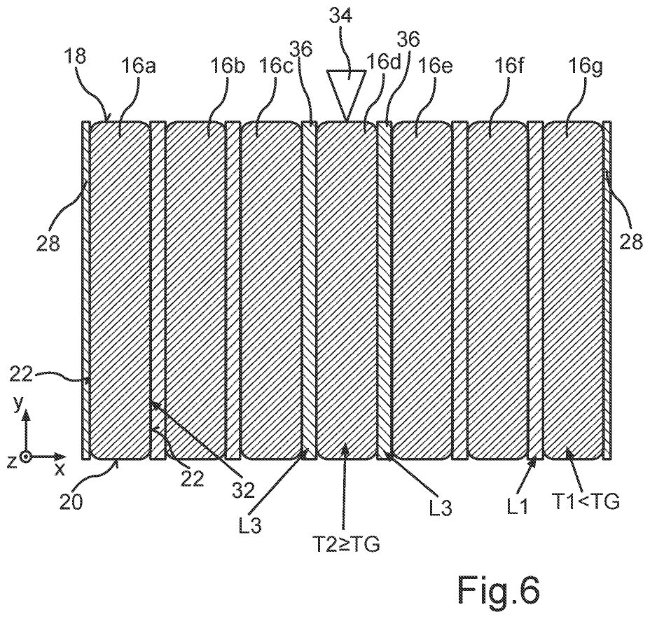

FIG. 6 shows, in reference to the components shown and described in connection with FIG. 1 to FIG. 5, the second embodiment of the battery module 14 in a fourth operating state. After a predetermined time period of the second temperature T2, the encasing material 30 has a third thermal conductivity L3 which is lower than the second thermal conductivity L2. If, at the second temperature T2 of the at least one battery cell 16d, the second thermal conductivity L2 is initially at first partially present in the encasing material 30, then, after the predetermined time period, the second thermal conductivity L2 decreases to the third thermal conductivity L3, so that a thermal insulation can be implemented.

Thus, the two functional layers 24, 26 (pads) with their different functions can instead be substituted by a material, i.e., the encasing material 30, which performs both functions. As a cost effective and simply implemented possibility, it would be possible, for example, to use a gel and/or a foam, which, however, usually can decompose at high temperatures (T2≥TG) which can occur during the runaway of the battery cell 16d. Therefore, the encasing material 30 used can be silicone-based. An encasing material 30 designed in this manner also decomposes at high temperature; however, it can be formulated so that it decomposes to form a dimensionally stable ceramic (silicatization). Thereby, the encasing material 30 has both properties:it is soft normal operation and can absorb pressure forces (T1<TG)—in the case of failure, it thermally insulates (T2≥TG). Here, it insulates up to a decomposition temperature (T1<TG) due to its low thermal conductivity (first thermal conductivity L1), it absorbs energy during the silicatization (T2≥TG) and thereby cools (second thermal conductivity L2). In a ceramic state, it insulates (third thermal conductivity L3) in a manner similar to that of a thermal insulation layer (for example, second layer 26).

Overall, the examples show how by means of a thermal insulation layer substituted by a silicone layer (encasing material 30 with silicone) (second layer 26) and a swelling pad (first layer 24) can be provided.

1. A battery module for a battery of a motor vehicle, comprising:
multiple battery cells, wherein each of the battery cells is at least partially encased by an encasing material comprising a silicone,
wherein at a first temperature (T1) of each of the battery cells lower than a limit temperature (TG) predetermined by the encasing material (30), the encasing material has a first thermal conductivity (L1),
wherein, at a second temperature (T2) of at least one battery cell of the multiple battery cells (16a-16g), higher than or equal to the limit temperature (TG), the encasing material at least partially has a second thermal conductivity (L2), wherein the second thermal conductivity (L2) is increased with respect to the first thermal conductivity (L1).

2. The battery module according to claim 1, wherein, after a predetermined time period of the second temperature (T2), the encasing material has a third thermal conductivity (L3) instead of the second thermal conductivity (L2), wherein the third thermal conductivity (L3) is lower than the second thermal conductivity (L2).

3. The battery module according to claim 1, wherein, below the limit temperature (TG), the encasing material applies a predetermined pressure to each of the battery cells, in order to control an expansion of each of the battery cells.

4. The battery module according to claim 1, wherein, in an immediate vicinity of the at least one battery cell having the second temperature (T2), the encasing material comprises Si—O groups and/or Si—OH groups generated by the second temperature (T2).

5. The battery module according to claim 1, wherein, proceeding from a contact surface with the at least one battery cell having the second temperature (T2), the encasing material forms a covering layer having the second thermal conductivity (L2) with a layer thickness (d) of maximum 1.5 millimeters.

6. The battery module according to claim 1, wherein the limit temperature (TG) of the encasing material is between 300 and 500 degrees Celsius.

7. The battery module according to claim 1, wherein the encasing material has multiple hollow bodies encased by the silicone with a volume proportion between 70 and 90 percent.

8. The battery module according to claim 1, wherein each of the battery cells is delimited by an upper side, a lower side, and at least one side surface, wherein
the at least one side surface is covered by the encasing material, wherein
the upper side and the lower side are each not covered by the encasing material.

9. A motor vehicle with a battery, comprising a battery module according to claim 1.

10. A method for operating a battery module for a battery of a motor vehicle, wherein the battery module comprises multiple battery cells, wherein each of the battery cells is at least partially encased by an encasing material comprising a silicone, wherein the encasing material predetermines a limit temperature (TG) for two thermal conductivities (L1, L2) which are different from one another, the method comprising the following steps:
(S1) operating each of the battery cells at a first temperature (T1) lower than the limit temperature (TG), wherein the encasing material has a first thermal conductivity (L1), and
(S2) operating at least one battery cell of the multiple battery cells with a second temperature (T2) higher than or equal to the limit temperature (TG), wherein the first conductivity (L1) of the encasing material is at least partially increased to a second thermal conductivity (L2).

11. The battery module according to claim 2, wherein, below the limit temperature (TG), the encasing material applies a predetermined pressure to each of the battery cells, in order to control an expansion of each of the battery cells.

12. The battery module according to claim 2, wherein, in an immediate vicinity of the at least one battery cell having the second temperature (T2), the encasing material comprises Si—O groups and/or Si—OH groups generated by the second temperature (T2).

13. The battery module according to claim 3, wherein, in an immediate vicinity of the at least one battery cell having the second temperature (T2), the encasing material comprises Si—O groups and/or Si—OH groups generated by the second temperature (T2).

14. The battery module according to claim 2, wherein, proceeding from a contact surface with the at least one battery cell having the second temperature (T2), the encasing material forms a covering layer having the second thermal conductivity (L2) with a layer thickness (d) of maximum 1.5 millimeters.

15. The battery module according to claim 3, wherein, proceeding from a contact surface with the at least one battery cell having the second temperature (T2), the encasing material forms a covering layer having the second thermal conductivity (L2) with a layer thickness (d) of maximum 1.5 millimeters.

16. The battery module according to claim 4, wherein, proceeding from a contact surface with the at least one battery cell having the second temperature (T2), the encasing material forms a covering layer having the second thermal conductivity (L2) with a layer thickness (d) of maximum 1.5 millimeters.

17. The battery module according to claim 2, wherein the limit temperature (TG) of the encasing material (30) is between 300 and 500 degrees Celsius.

18. The battery module (14) according to claim 3, wherein the limit temperature (TG) of the encasing material is between 300 and 500 degrees Celsius.

19. The battery module according to claim 4, wherein the limit temperature (TG) of the encasing material is between 300 and 500 degrees Celsius.

20. The battery module according to claim 5, wherein the limit temperature (TG) of the encasing material is between 300 and 500 degrees Celsius.
